(19) United States
(12) Patent Application Publication
(10) Pub. No.: US 2024/0230903 A9
(43) Pub. Date: Jul. 11, 2024

(54) TRANSPORT POSSIBILITY DETERMINATION DEVICE, DISTANCE MEASUREMENT DEVICE, TRANSPORT UNIT, TRANSPORT POSSIBILITY DETERMINATION METHOD, AND TRANSPORT POSSIBILITY DETERMINATION PROGRAM

(71) Applicant: OMRON CORPORATION, Kyoto-shi, Kyoto (JP)

(72) Inventors: Benika INOUE, Kyoto-shi (JP); Masahiro KINOSHITA, Kyoto-shi (JP); Akihiro ISHII, Kyoto-shi (JP); Mitsunori SUGIURA, Kyoto-shi (JP); Ryoji SHIMIZU, Kyoto-shi (JP)

(73) Assignee: OMRON CORPORATION, Kyoto-shi, Kyoto (JP)

(21) Appl. No.: 18/548,236

(22) PCT Filed: Jan. 17, 2022
(86) PCT No.: PCT/JP2022/001362

§ 371 Date: Aug. 29, 2023

(30) Foreign Application Priority Data
Mar. 12, 2021 (JP) 2021-040681

(51) Int. Cl. G01S 17/42; B66F 9/24; G01S 7/48; G01S 17/04; G01S 17/93

(52) U.S. Cl. CPC G01S 17/42; B66F 9/24; G01S 7/4808; G01S 17/04; G01S 17/93

(57) ABSTRACT

A transport possibility determination device comprises a distance measurement unit and a control unit. The distance measurement unit acquires information about the distance to an object. The control unit determines the state of a load when the object is a transport platform on which the load has been placed, on the basis of the information about the distance to the object acquired by the distance measurement unit. The control unit determines whether or not a transportable condition, which is a condition for permitting a forklift to transport the load, is met on the basis of the determined state of the load.

### TECHNICAL FIELD

The present invention relates to a transport possibility determination device for determining whether or not a load placed on a transport platform can be transported, as well as to a distance measurement device comprising this transport possibility determination device, a transport possibility determination method, and a transport possibility determination program.

### BACKGROUND ART

Forklifts are widely used as a transport device for lifting and transporting a load placed on a transport platform such as a pallet, along with the transport platform.

Some forklifts are equipped with an object detection device that detects objects in the surrounding area (see, for example, Patent Literature 1).

In Patent Literature 1, the position of an object that would hinder the movement of the forklift (such as an obstacle or a wall) is sensed by using an object detection device to process an image captured by a stereo camera. In order to avoid collision with such an object, the main controller of the forklift performs deceleration processing on the basis of the detection result of the object detection device.

### CITATION LIST

### Patent Literature

Patent Literature 1: JP-A 2020-57258

### SUMMARY

However, with image processing, it is difficult to identify transport objects that are supposed to be transported by a forklift, such as a transport platform and a load. For example, a transport platform has a receiving portion into which the forks are inserted. However, it can be difficult to detect this receiving portion from a processed image and distinguish it from a shape or pattern given to an object having an outer shape similar to that of the transport platform, and as a result, there are cases in which a transport object cannot be identified.

### Technical Problem

Accordingly, even if it is possible to execute processing related to the safe travel of a forklift on the basis of the detection result obtained by an object detection device, it is still difficult to execute processing related to transport by the forklift.

### Solution to Problem

In view of this, it is an object of the present invention to increase the accuracy with which a transport object is identified from objects located around the transport device, thereby assisting in the operation control of the transport device.

The transport possibility determination device according to one mode of the present invention comprises a distance information acquisition unit, a determination unit, and a condition determination unit. The distance information acquisition unit acquires information about the distance to an object according to the amount of reflection of electromagnetic waves emitted from a lighting device at the object. The determination unit determines the state of a load when the object is a transport platform on which the load has been placed, on the basis of the information about the distance to the object acquired by the distance information acquisition unit. The condition determination unit determines whether or not a transportable condition, which is a condition for permitting a transport device to transport the load, is satisfied on the basis of the state of the load determined by the determination unit.

Here, the transport device holds and lifts a transport platform. The word “transport” here also encompasses just raising and lowering, without any horizontal movement of the transport platform. The transport device includes a self-propelled type that has a power source for moving the main body (chassis), and a non-self-propelled type that has no such power source.

Non-self-propelled transport devices include, for example, a power lifter, a conveyance robot (manipulator), and the like, and may be configured to be pushable by hand. Self-propelled transport devices include, for example, forklifts and the like. Self-propelled transport devices include those configured as manned vehicles equipped with members for human operation (steering wheel, levers, pedals, etc.), and also include AGVs (automatic guided vehicle), AMRs (autonomous mobile robots), and other such automatic transport machines constituted by an automatic driving vehicle that can move around without any human driving input.

That is, for example, a mechanism for holding and lifting a transport platform, such as arm portions, may be attached to the main body of a manned vehicle, or may be attached to the main body of an unmanned vehicle.

The transport platform is a loading platform on which a load is placed and which is transported together with the load by a transport device, and may be made of any material, such as wood or resin. The transport platform has, for example, a receiving portion such as a hole or a recess into which an arm member of a forklift or other such transport device is inserted. Examples of transport platforms include flat pallets, sheet pallets, and so forth.

Examples of the electromagnetic waves emitted from the lighting device include light in the usual sense (ultraviolet light, visible light, and infrared light), X-rays and gamma rays with shorter wavelengths than light, microwaves with longer wavelengths than light, and broadcasting radio waves (short wave, medium wave, long wave), ultrasonic waves, elastic waves, quantum waves, and so on.

The distance information acquisition unit may be configured to calculate distance information by detecting the reflection of electromagnetic waves, or may be configured to acquire distance information from a distance sensor or the like provided as an external device, for example.

With the above configuration, the system refers to information about the distance to an object according to the amount of reflection of the electromagnetic waves. Therefore, it is easier to distinguish between a shape provided on the transport platform and a shape or pattern given to an object having an outer shape similar to that of the transport platform, and this boosts the accuracy at which the object to be transported is identified.

It is also possible to distinguish and identify the transport platform and the load from the transport object on the basis of the information about the distance to the load and the information about the distance to the transport platform, and it is also possible to determine the state of the load.

The condition determination unit determines whether or not the load can be transported by the transport device on the basis of the state of the load.

Consequently, since the state of the load is determined very accurately, problems such as collapse of the load during transport when it has been determined that the load can be transported are less likely to occur.

The determination unit may determine the relative position of the load with respect to the transport platform as the state of the load. The transportable condition may include a position condition that the relative position be positioned within a specific reference area.

With the above configuration, transport by the transport device is permitted when the relative position of the load with respect to the transport platform is within a reference area. Conversely, transport is prohibited if the load is disposed unevenly with respect to the transport platform. Therefore, the transport device can stably transport the load without any need for a worker to monitor the relative position.

The determination unit may determine the orientation of the load with respect to the transport platform as the state of the load. The transportable condition may include an orientation condition that the orientation of the load with respect to the transport platform be within a specific reference range.

With the above configuration, transport by the transport device is permitted when the orientation of the load with respect to the transport platform is within a reference range. Conversely, transport is prohibited if the load is disposed unevenly with respect to the transport platform. Therefore, the transport device can stably transport the load without any need for a worker to monitor the orientation.

The determination unit may determine the shape of the load as the state of the load. The transportable condition may include a shape condition that the shape of the load be within a specific reference range.

With the above configuration, transport by the transport device is permitted when the shape of the load is within a reference range. Conversely, transport is prohibited if the shape of the load is out of the expected range. Therefore, the transport device can stably transport the load without any need for a worker to monitor the shape.

The determination unit may determine the height of the load as the state of the load. The transportable condition may include a height condition that the height be within a specific reference height.

With the above configuration, transport by the transport device is permitted when the height of the load is within a reference height. Conversely, transport is prohibited if the load exceeds the reference height. Therefore, the transport device can stably transport the load without any need for a worker to monitor the height.

The determination unit may determine whether or not an object is a transport platform on the basis of distance information.

With the above configuration, even in a case where a black drawing or the like is made on the side surface of the object placed on the floor, for example, in order to determine whether or not an object to be measured is a transport platform by using information about the distance to the object, distance information can be used to detect whether or not there is a feature of the transport platform transported by the transport device (receiving portion such as recesses or holes into which arm portions of the transport device are inserted, for example). As a result, whether or not the detected object is a transport platform can be accurately determined.

The transport platform may have a receiving portion into which an arm member of the transport device is inserted. The determination unit may use distance information to determine whether or not an object is a transport platform on the basis of at least one of the presence or absence, size, and position of the receiving portion.

With the above configuration, the receiving portion is detected using distance information, and the determination unit determines whether or not an object is a transport platform according to the detection result for the presence or absence, size, position, etc., of the receiving portion. Since the receiving portion is one of the main characteristic parts of the transport platform, whether or not an object is a transport platform can be accurately determined.

The transport platform may have a receiving portion into which the arm member of the transport device is inserted. The determination unit may use distance information to determine whether an object is an empty transport platform, or the transport platform on which the load has been placed, or an object other than the transport platform according to at least one of the following: the presence or absence, size, and position of the receiving portion.

As discussed above, the receiving portion is one of the main characteristic parts of a transport platform, so the determination unit can accurately determine the state of the transport platform (empty, loaded, or not a transport platform) according to the detection result for the presence or absence, size, position, etc., of the receiving portion).

The determination unit may use distance information to detect the floor surface on which an object is placed, and may detect an object having a height above the floor surface as a candidate for a transport platform.

Consequently, candidates for being a transport platform can be accurately detected on the basis of their sensed height from the floor surface.

The determination unit may set the outer shape of the object detected as a candidate for the transport platform on the basis of distance information.

Since distance information is referred to, the outer shape of the object detected as a candidate for the transport platform can be set accurately.

The determination unit may set the outer shape using binarized data obtained on the basis of distance information or information about the brightness of a captured image of the object.

Consequently, the outer shape of an object can be set using binarized data obtained on the basis of distance information or information about the brightness of a captured image of the object.

If the determination unit cannot obtain binarized data, the exposure time for emitting and receiving the electromagnetic waves emitted from the lighting device may be adjusted.

Consequently, if binarized data cannot be obtained, the exposure time for emitting and receiving the electromagnetic waves emitted from the lighting device can be adjusted to obtain properly binarized data, allowing the outer shape of the object to be set accurately.

The determination unit may set a detection surface on which the receiving portion of the transport platform is assumed to be formed, on the basis of the outer shape that has been set.

Consequently, a detection surface where the receiving portion is thought to be located can be set from the outer shape that has been set.

The determination unit may determine whether or not an object is a transport platform according to information about the depth of the receiving portion of the transport platform on the detection surface.

Consequently, the acquired distance information can be used to detect whether there is any depth on the detection surface, making it possible to accurately determine whether or not an object is a transport platform having a receiving portion.

The determination unit may detect the position in a substantially horizontal direction of the load existing at the same axial coordinates as the detection surface of the object assumed to be the transport platform, and determine the state of the load.

Consequently, the position, size, bias, etc., of the load can be determined by detecting the position in the substantially horizontal direction of the load existing at the same axial coordinates as the detection surface of an object assumed to be a transport platform.

The determination unit may sense the orientation of the load with respect to the detection surface of an object assumed to be a transport platform, and determine the state of the load.

Consequently, the state of the load with respect to the transport platform, such as its orientation or bias, can be determined by detecting the orientation of the load with respect to the detection surface of an object assumed to be a transport platform.

The transport possibility determination device may further comprise a storage unit that stores detection data about the transport platform determined by the determination unit to be a transport platform.

Consequently, by registering data (outer shape, size, position of the receiving portion, etc.) of a transport platform determined to be a transport platform in the storage unit, the balance of the load and so forth can be determined by subsequently recognizing the boundary between the transport platform and the load that has been placed on the transport platform, for example.

The electromagnetic waves may be infrared rays.

Consequently, if distance information calculated according to the amount of reflected infrared rays is acquired, it will be possible to accurately determine whether or not an object is a transport platform even when the transport work is being performed in a dark area, for example.

The distance measurement device according to one mode of the present invention comprises the above-mentioned transport possibility determination device, a lighting device, and a light receiving unit. The lighting device irradiates the object with electromagnetic waves. The light receiving unit senses the amount of reflection of the electromagnetic waves emitted from the lighting device.

With the above configuration, the light receiving unit detects the reflection from the object of the electromagnetic waves emitted from the lighting device, which allows information about the distance to the object to be calculated (acquired) according to the amount of reflection. Consequently, whether or not the vehicle is a transport platform, the state of the load, and so forth can be accurately determined according to the calculated distance information.

The distance measurement device may further comprise a control unit that adjusts the amount of electromagnetic waves emitted from the lighting device, and the exposure time for the light receiving unit to sense the amount of reflection of the electromagnetic waves.

Consequently, the electromagnetic waves can be emitted and the reflection of electromagnetic waves can be received at an exposure time that is appropriate for the distance to the object by adjusting the exposure time with the control unit. Also, whether or not an object is a transport platform, the state of the load, and so forth can be accurately determined using distance information by adjusting to an exposure time that is appropriate for obtaining binarized data.

The controller may adjust the exposure time according to the distance to the object.

Consequently, when the distance to the object is short, for example, the control unit shortens the exposure time, and lengthens the exposure time when the distance to the object is long, which allows the electromagnetic waves to be emitted and the reflection of electromagnetic waves to be received at an exposure time that is appropriate for the distance to the object.

The transport unit according to one mode of the present invention comprises the above-mentioned distance measurement device and a transport device that transports the load placed on the transport platform.

Consequently, it is possible to construct a transport unit in which it is determined whether to permit or prohibit the operation of the transport device on the basis of the determination result of the condition determination unit.

The transport device may comprise an arm member that is inserted into a receiving portion of the transport platform, and a transport control unit that controls the operation of the arm member. When the condition determination unit determines that the transportable condition has been satisfied, the transport control unit controls the operation of the arm member on the basis of the state of the load determined by the determination unit.

Consequently, the load is transported if the transportable condition is met, and the load is not transported if the transportable condition is not met. When the transportable condition is met, the movement of the arm member is controlled on the basis of the state of the load. This allows the transport device to transport the load stably.

The transport possibility determination method according to one mode of the present invention comprises a distance information acquisition step, a determination step, and a transport possibility determination step. The distance information acquisition step involves acquiring information about the distance to an object according to the amount of reflection of electromagnetic waves emitted from the lighting device at the object. The determination step involves determining the state of a load when the object is a transport platform on which the load has been placed, on the basis of the information about the distance to the object acquired in the distance information acquisition step. The transport possibility determination step involves determining whether or not a transportable condition, which is a condition for permitting a transport device to transport the load, is satisfied on the basis of the state of the load determined in the determination step.

The transport possibility determination program according to one mode of the present invention causes a computer to execute the above-mentioned transport possibility determination method.

The method and program described above have technical features corresponding to the technical features of the transport possibility determination device described above.

Therefore, when it is determined that a load can be transported on the basis of the accurately determined state of the load, problems such as collapse of the load during transport will be less likely to occur.

### Advantageous Effects

With the present invention, the operation control of a transport device can be assisted by boosting the accuracy with which a transport object is identified from objects located around the transport device.

### BRIEF DESCRIPTION OF DRAWINGS

FIG. 1 is a diagram showing a transport unit and a transport platform to be transported in an embodiment of the present invention;

FIG. 2A is an oblique view of the transport platform that is transported by the forklift in FIG. 1, and FIG. 2B is an oblique view of another example of the transport platform;

FIG. 3 is a control block diagram of the transport unit in FIG. 1;

FIG. 4 is a diagram illustrating the principle behind calculating the distance to an object with the distance measurement device in FIG. 1 by TOF method;

FIG. 5 is a transport platform table that is stored in the storage unit included in the transport possibility determination device in FIG. 3;

FIG. 6 is a flowchart showing the flow of the processing of the transport possibility determination method by the transport possibility determination device in FIG. 1;

FIG. 7 is a flowchart showing the flow of the processing of the transport possibility determination method by the transport possibility determination device in FIG. 1;

FIGS. 8A, 8B, and 8C are schematic diagrams illustrating the step of detecting a transport platform;

FIG. 9A is an oblique view of the surface defined in the flowchart of FIG. 10 and an object with no depth information (holes) on this surface, and FIG. 9B is an oblique view of the surface defined in the flowchart of FIG. 10 and an object having depth information (holes) on this surface;

FIG. 10 is a flowchart showing the flow of processing in a transport state detection method by the transport possibility determination device in FIG. 1;

FIG. 11A is a front view showing the size in the x axis direction of the detection plane of the transport possibility determination device, FIG. 11B is a plan view showing the detection direction of the transport state detection unit, and FIG. 11C is a plan view showing the positional relationship between the detection direction of the transport possibility determination device and the transport platform;

FIG. 12 is a plan view showing the positional relationship between the transport platform and a load that has been placed thereon;

FIG. 13 is a flowchart showing the flow of processing in the transport possibility determination method in this embodiment; and

FIG. 14 is a conceptual diagram illustrating the detection of a transport platform in a dark room.

### DESCRIPTION OF THE EMBODIMENTS

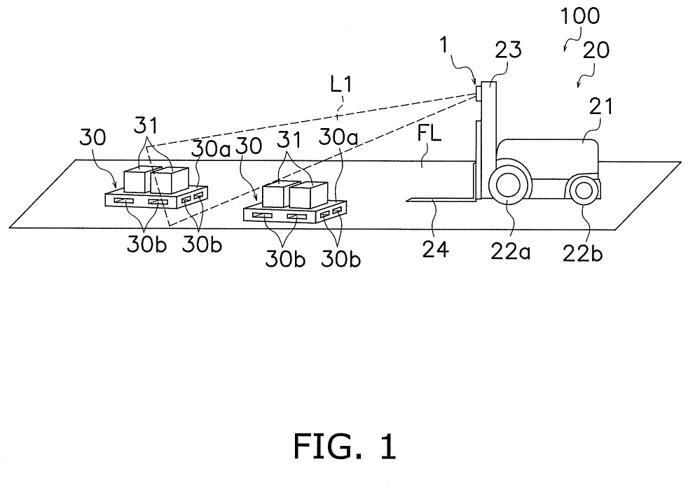

A transport possibility determination device 10 according to an embodiment of the present invention, a distance measurement device 1 equipped with the transport possibility determination device 10, a forklift (transport device) 20 in which the distance measurement device 1 is installed, and a transport unit 100 equipped with the distance measurement device 1 and the forklift 20 will now be described with reference to FIGS. 1 to 13.

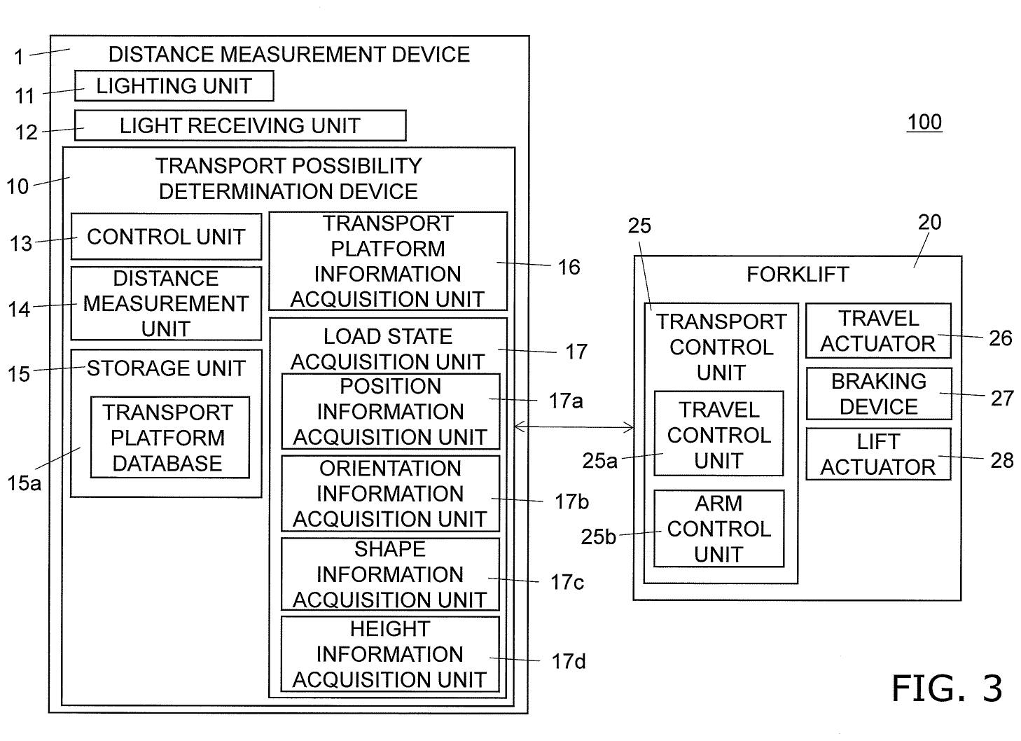

As shown in FIGS. 1 and 3, the transport unit 100 comprises the distance measurement device 1 and the forklift 20.

(1) Forklift 20

As shown in FIG. 1, the forklift (transport device) 20 holds and lifts a transport platform 30 on which a load 31 has been placed. Furthermore, the forklift 20 moves the lifted transport platform 30 to the desired position.

The forklift 20 in this embodiment is, for example, a “manned type” that is operated by a driver sitting in the forklift. The driving operation is assisted on the basis of the results of the detection of the transport platform 30 and the state of the load 31 on the transport platform 30 by the transport possibility determination device 10.

The forklift 20 may be an autonomous transport device that does not need to be driven by a driver. In this case, autonomous operation is carried out on the basis of the results of detection of the transport platform 30 and the state of the load 31 on the transport platform 30 by the transport possibility determination device 10.

The forklift 20 includes a vehicle body portion 21, four wheels 22a and 22b, a drive unit 23, arm portions (forks) 24, a transport control unit 25 (see FIG. 3), a travel actuator 26 (see FIG. 3), a braking device 27 (see FIG. 3), and a lift actuator 28 (see FIG. 3).

The vehicle body portion 21 has an accelerator pedal, a steering handle, a brake pedal, and a driver's seat provided with operation members (not shown) such as operation levers that are operated by the driver. The vehicle body portion 21 holds a driving source such as an engine or a motor for traveling.

Two wheels 22a and two wheels 22b are provided at the front and rear of the vehicle body portion 21. For example, the front wheels 22a are the drive wheels and the rear wheels 22b are the steering wheels. The front wheels 22a are rotationally driven by a travel actuator 26, and the rear wheels 22b are steered, allowing the forklift 20 (vehicle body portion 21) to travel and turn.

The drive unit 23 is provided in front of the vehicle body portion 21. The drive unit 23 drives the arm portions 24 up and down or in the tilt direction according to operation of the control lever by the driver. The arm portions 24 are inserted into holes (receiving portions) 30b or the like provided to the transport platform 30 to support the transport platform 30. The drive unit 23 includes, for example, a lift actuator such as a hydraulic cylinder, a mast, sprockets, chains, etc. The arm portions 24 are, for example, two claw-shaped members extending forward.

In a state in which the arm portions 24 are inserted into the holes 30b, the drive unit 23 drives the arm portions 24 upward, so that the transport platform 30 is supported by the arm portions 24 and lifted. As the vehicle body portion 21 travels in this state, the transport platform 30 is moved to the desired location.

The transport control unit 25 is a controller that controls transport by the forklift 20, and controls whether transport by the forklift 20 is permitted or prohibited on the basis of the determination result obtained by the transport possibility determination device 10 (discussed below). As shown in FIG. 3, the transport possibility determination device 10 has a travel control unit 25a and an arm control unit 25b.

The travel control unit 25a controls the output of the drive source, such as an engine or a motor, so that the speed of the forklift 20 reaches a target speed. The arm control unit 25b controls the lifting of the arm portions 24 according to the amount of operation of an operating lever (not shown) installed in the driver's seat provided to the vehicle body portion 21. Also, the arm control unit 25b may perform control so that the spacing of the two arm portions 24 is automatically adjusted to match the sensed position of the holes 30b in the transport platform 30 according to the detection result of the transport platform 30 (discussed below). Accordingly, the forklift 20 may include a spacing adjustment mechanism for adjusting the spacing of the arm portions 24. The forklift 20 may also be provided with a telescopic adjustment mechanism that independently adjusts the amount of extension of the left and right arms.

The travel actuator 26 is configured to include a drive source used for travel, and a drive transmission means for transmitting the output of the drive source to the wheels 22a of a drive side.

The braking device 27 is provided to reduce the speed of the moving forklift 20 or to bring it to a stop. The braking device 27 applies braking force to the wheels 22a according to the amount of operation of a brake pedal provided to the driver's seat.

The lift actuator 28 is provided to the drive unit 23 and includes, for example, hydraulic cylinders such as lift cylinders and tilt cylinders. The hydraulic cylinders change the angle of the arm portions 24 in the tilt direction or move the position of the arm portions 24 up and down according to the amount of operation of an operation lever (not shown) installed in the driver's seat.

(2) Transport Platform 30

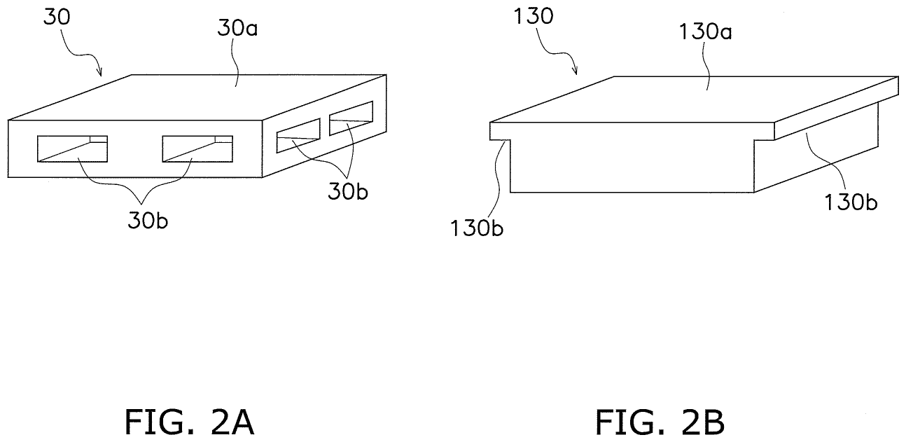

Here, the transport platform 30 transported by the forklift 20 in this embodiment will be described with reference to FIGS. 2A and 2B.

The transport platform 30 is a pallet made of resin, and as shown in FIG. 2A, has a main body portion 30a and holes (receiving parts) 30b.

The main body portion 30a is, for example, a pallet made of reusable PP (polypropylene) or another such resin, and has an upper surface on which the load 31 is placed, four side surfaces, and a bottom surface.

The four side surfaces of the main body portion 30a have formed in them the holes 30b into which the arm portions 24 of the forklift 20 can be inserted.

Two holes (receiving portions) 30b are provided in each of the four side surfaces of the body portion 30a, and the two arm portions 24 of the forklift 20 can be inserted therein.

The holes 30b into which the arm portions 24 of the forklift 20 are inserted may be provided on all four side surfaces of the main body portion 30a, for example, or may be provided only on two opposing side surfaces, or may be provided on only one surface.

As for the type of transport platform 30 transported by the forklift 20, as shown in FIG. 2B, it may be a transport platform 130 provided with recesses 130b on both side surfaces of the main body portion 130a, instead of the holes 30b into which the arm portions 24 are inserted.

In this case, instead of being inserted into the holes 30b, the arm portions 24 of the forklift 20 are inserted between the floor surface FL and the upper surfaces forming the recesses 130b, and the transport platform 130 can be lifted so as to support the recesses 130b from below.

(3) Transport Possibility Determination Device 10

The transport possibility determination device 10 of this embodiment is provided to the distance measurement device 1 attached to the upper part of the drive unit 23 as shown in FIGS. 1 and 3. The transport possibility determination device 10 detects a transport platform 30 to be transported by the forklift 20, and also detects the state (position, range, height, balance, etc.) of the load 31 placed on the transport platform 30. Furthermore, the transport possibility determination device 10 determines whether or not transport is possible according to the state of the load.

As shown in FIG. 3, the distance measurement device 1 comprises a lighting unit (lighting device) 11, a light receiving unit 12, and the transport possibility determination device 10. The transport possibility determination device 10 comprises a control unit (determination unit and condition determination unit) 13, a distance measurement unit 14, a storage unit 15, a transport platform information acquisition unit 16, and a load state acquisition unit (determination unit) 17.

The lighting unit (lighting device) 11 has an LED, for example, and illuminates an object, such as the transport platform 30 or the load 31, with light L1 of the desired wavelength. The lighting unit 11 is provided with a projection lens (not shown) that guides the light L1 emitted from the LED toward the object.

The light receiving unit 12 includes a light receiving lens and an imaging element, for example.

The light receiving lens is provided in order to receive light that is emitted from the lighting unit 11 toward the object and reflected by the object, and guide this light to an imaging element.

The imaging element has a plurality of pixels. The reflected light received by the light receiving lens is received by each of the pixels, and an electrical signal obtained by photoelectric conversion is transmitted to the control unit 13. An electrical signal corresponding to the amount of reflected light received by the image sensor is used by the control unit 13 to calculate distance information.

The control unit 13 reads various control programs stored in the storage unit 15 and controls the lighting unit 11 that irradiates the target with light. More precisely, the control unit 13 controls the lighting unit 11 so as to emit the optimal light according to the distance to the object to be irradiated with the light, and the shape, color, and other such properties of the object. Also, the control unit 13 determines whether or not the object is the transport platform 30 on the basis of the characteristics of the object (discussed below), and determines whether or not the loading state of the load 31 placed on the transport platform 30 is correct. Furthermore, the control unit 13 determines whether or not the load 31 can be transported according to the state of the load 31.

Also, the control unit 13 adjusts the light emitted from the lighting unit 11 and the exposure time of the light receiving unit 12 for sensing the amount of reflection of the light emitted from the lighting unit 11 according to the distance to the object, for example. Alternatively, the control unit 13 adjusts the exposure times of the lighting unit 11 and the light receiving unit 12 depending on whether or not binarized data can be acquired (discussed below).

More specifically, the control unit 13 adjusts the exposure time to be shorter when the distance to the object is short, and adjusts the exposure time to be longer when the distance to the object is long.

The detection (determination) of the transport platform 30 and the sensing (determination) of the transport state by the control unit 13 will be described in greater detail below.

The distance measurement unit 14 calculates information about the distance to the object for each pixel on the basis of the electrical signals corresponding to the pixels received from the imaging element included in the light receiving unit 12.

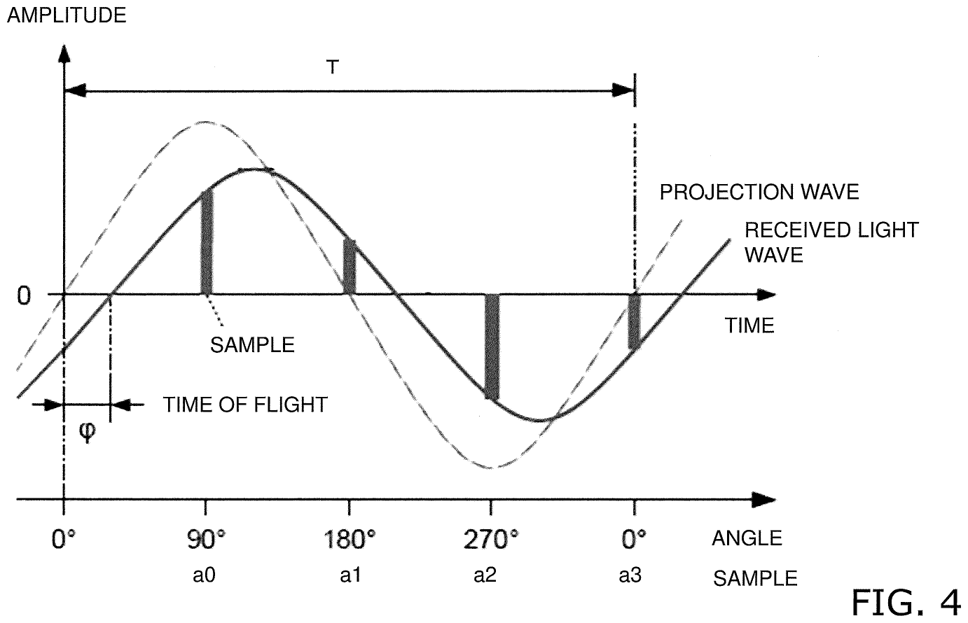

The calculation of information about the distance to an object by the distance measurement unit 14 in this embodiment will now be described with reference to FIG. 4.

In this embodiment, a so-called TOF (time of flight) method is used by the distance measurement unit 14 to calculate the distance to an object on the basis of the phase difference Φ (see FIG. 4) between a projection wave of an AM-modulated constant frequency, such as a sine wave or a rectangular wave, emitted from the lighting unit 11 and the light wave received by the imaging element included in the light receiving unit 12.

Here, the phase difference Φ is expressed by the following relational formula (1).

Φ=a tan(y/x) (1)

(where x=a2−a0, y=a3−a1, and a0−a3 are the amplitudes at the points where the received wave was sampled four times at intervals of 90 degrees)

A conversion formula from the phase difference Φ to the distance D is expressed by the following relational formula (2).

D=(c/(2×f_{LED}))×(Φ/2π)+D_{OFFSET} (2)

(where c is the speed of light (≈3×10⁸ m/s), f_{LED} is the modulation frequency of the LED projection wave, and D_{OFFSET} is the distance offset)

Consequently, the distance measurement unit 14 can easily use the speed of light c to calculate the distance to an object by receiving the reflection of the light emitted from the lighting unit 11 and comparing the phase difference.

The storage unit 15 stores various programs for controlling the operation of the transport possibility determination device 10, and also stores a transport platform database 15a in which is registered information about the characteristics of a transport platform 30 detected as the transport platform 30 (such as its size, the position of the holes 30b, etc.).

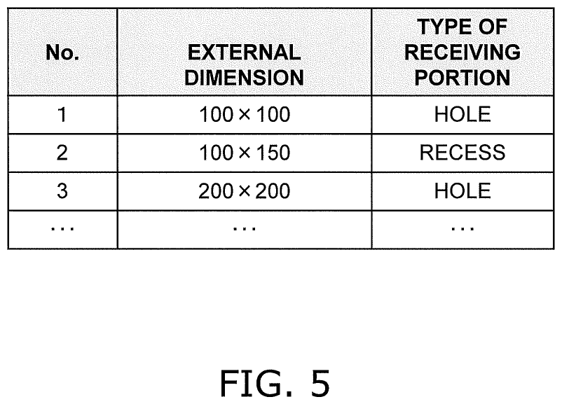

The transport platform database 15a stores a transport platform table (see FIG. 5) including information such as the external dimensions of the object determined to be a transport platform 30 and the type of receiving portion (holes or recesses). Consequently, the transport platform database 15a is referred to in determining what type of transport platform a detected object is.

The transport platform information acquisition unit 16 acquires object information about an object that is necessary for determining whether or not the object is the transport platform 30 (discussed below). More specifically, the transport platform information acquisition unit 16 acquires information such as the size (width, height, etc.) of an object assumed to be the transport platform 30, whether there are receiving portions (holes, recesses, etc.), and the positions of these.

The load state acquisition unit 17 detects the state of the load 31 placed on the object determined to be the transport platform 30. As shown in FIG. 3, the load state acquisition unit 17 has a position information acquisition unit 17a, an orientation information acquisition unit 17b, a shape information acquisition unit 17c, and a height information acquisition unit 17d.

The position information acquisition unit 17a senses the position of the load 31 on the object determined to be the transport platform 30.

The orientation information acquisition unit 17b senses the orientation of the load 31 with respect to the object determined to be the transport platform 30.

The shape information acquisition unit 17c senses information about the shape (outer shape, etc.) of the load 31 on the object determined to be the transport platform 30.

The height information acquisition unit 17d senses height information about the load 31 on the object determined to be the transport platform 30.

The position, orientation, shape, height, and other such information about the load 31 sensed by the position information acquisition unit 17a, the orientation information acquisition unit 17b, the shape information acquisition unit 17c, and the height information acquisition unit 17d are used in processing to determine the possibility of transport (discussed below).

Transport Platform Detection Method

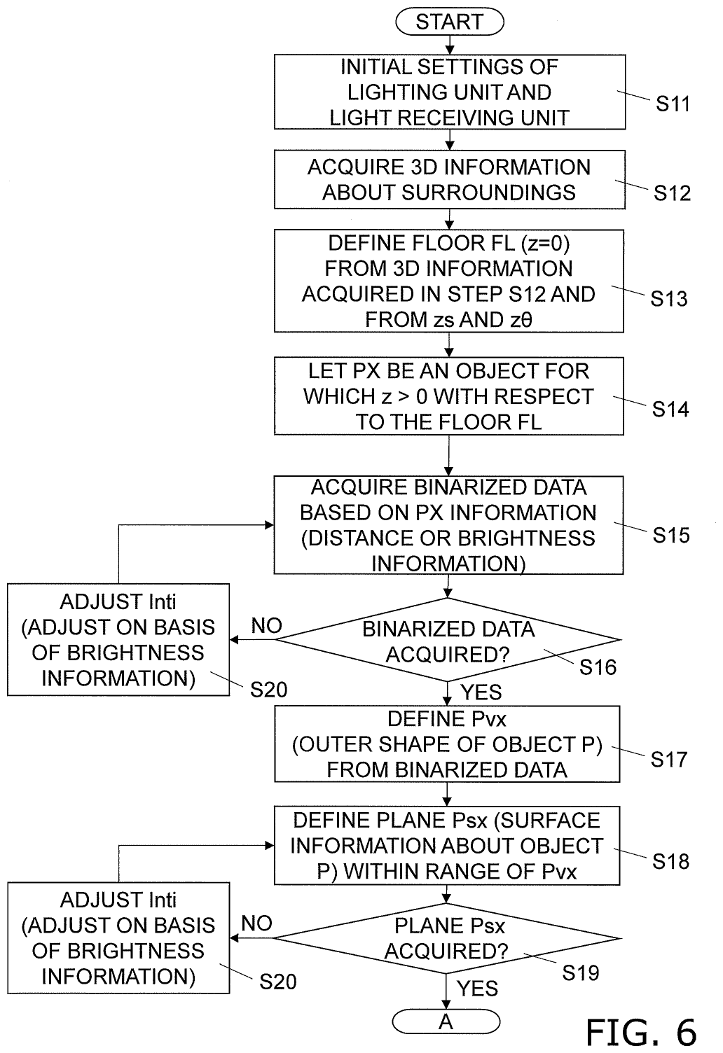

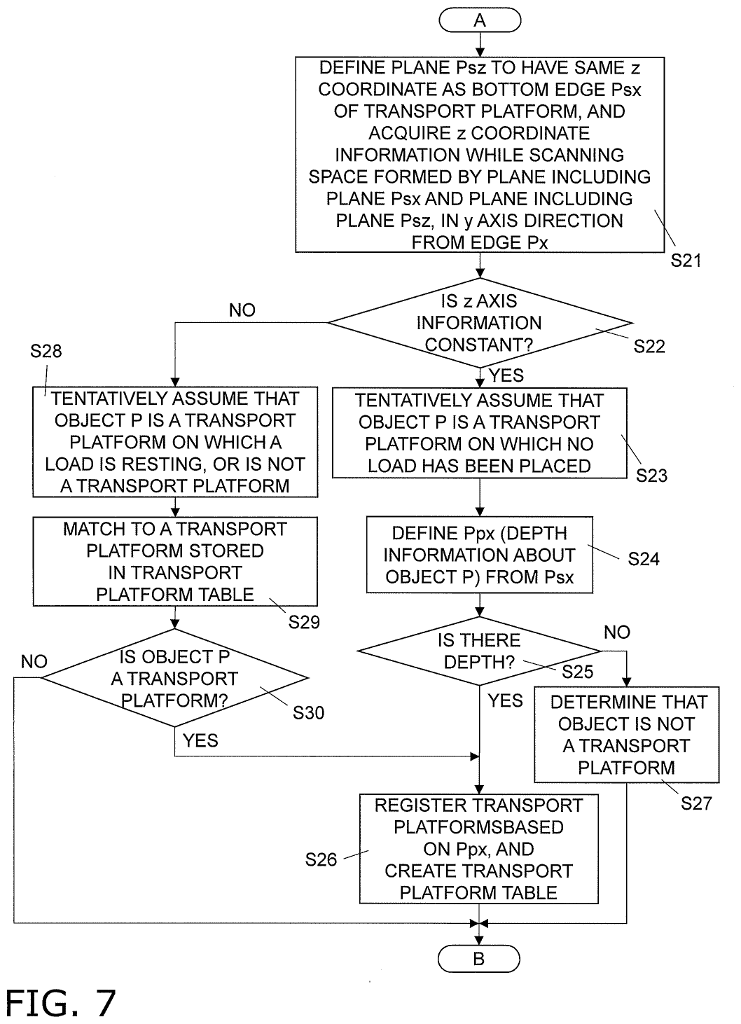

With the transport possibility determination method of this embodiment, first, the information about the distance to an object measured by the distance measurement unit 14 is used to determine whether or not the object is the transport platform 30, according to the flowcharts shown in FIGS. 6 and 7.

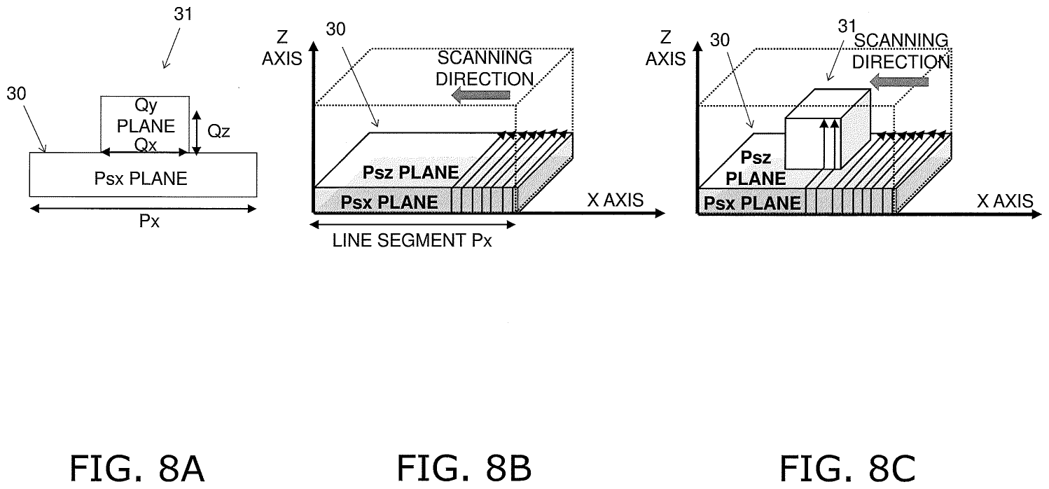

Here, zs is defined as the attachment position of the light receiving unit 12 (imaging element) relative to the floor surface FL (z=0); z θ as the attachment angle of the light receiving unit 12 (imaging element) with respect to the floor surface FL; the outer shape Pv, the plane Ps, and the depth information Pp as 3D shape information about an object (object P) assumed to be the transport platform 30 detected by the transport possibility determination device 10; the outer shape Pv and the receiving portion type Ps as 3D shape information about the transport platform table shown in FIG. 5; the outer shape Qv, the plane Qs, and the features Qp (such as unevenness) as 3D shape information about the object (Q) assumed to be the load 31; Inti as the exposure time initially set for the light receiving unit 12 (imaging element); Sy as the plane of the light receiving unit 12; and S (Sx/2) as the center point of the light receiving unit 12 (see FIGS. 8A and 8B).

The x axis is the direction perpendicular to the travel direction (horizontal direction), the y axis is the lengthwise direction (the travel direction of the forklift 20), and the z axis is the height direction (vertical direction) from the floor surface FL.

As shown in FIG. 6, in step S11, the exposure times of the lighting unit 11 (lighting device) and the light receiving unit 12 (imaging element) of the distance measurement device 1 are set to their initial settings.

Next, in step S12, the distance information measured (acquired) by the distance measurement unit 14 using the above-mentioned TOF method is used to obtain three-dimensional (3D) information.

Here, a case will be described in which the light emitted from the lighting unit 11 of the distance measurement device 1 is emitted forward of the forklift 20.

Next, in step S13, the floor surface FL (z=0) is defined from the three-dimensional information acquired in step S12 and the attachment position zs and attachment angle zθ of the light receiving unit 12 (imaging element).

The range of the three-dimensional information acquired here is decided according to the performance (angle of view, etc.) of the imaging element of the light receiving unit 12.

Next, in step S14, an object P that satisfies z>0 with respect to the floor surface FL (z=0), that is, an object that is taller than the floor surface FL, is detected.

Next, in step S15, binarized data is acquired on the basis of information PX about the object P (distance or brightness information).

The binary data acquired here is preferably acquired on the basis of brightness information rather than distance information because of the fact that the data can be acquired stably regardless of the resolution.

Next, in step S16, it is determined whether or not the binarized data has been properly acquired, that is, whether or not the edge of the object P (and object Q) has been detected. Here, if the binarized data has been acquired properly, the processing proceeds to step S17. On the other hand, if the binarized data has not been acquired properly, the processing proceeds to step S20, where the exposure time Inti of the lighting unit 11 (lighting device) and the light receiving unit 12 (imaging element) is adjusted.

Next, in step S17, Pvx (the outer shape of the object P) is defined using the binarized data because it was determined in step S16 that the binarized data was properly acquired.

Next, in step S18, a plane Psx (surface information about the object P) within the range of the outer shape Pvx of the object P is defined from the distance information corresponding to each pixel of the image sensor acquired by TOF method.

In this embodiment, the side surface portion of the object P where receiving portions such as the holes 30b might be formed is defined as the plane Psx.

Next, in step S19, it is determined whether or not the plane Psx has been acquired, and if it has, the processing proceeds to the flowchart shown in FIG. 7, but if it has not been acquired, the exposure time Inti of the lighting unit 11 (lighting device) and the light receiving unit 12 (imaging element) is adjusted just as in step S20, and the processing goes back to step S18.

Here, in step S20, since it was determined in step S16 that the binarized data was not properly acquired, the exposure time Inti is adjusted on the basis of the brightness information acquired by the light receiving unit 12 (imaging element).

For example, if the brightness of the information PX of the object P is high, saturation may occur, so the exposure time is adjusted to be shorter. On the other hand, if the brightness of the information PX of the object P is low, the imaging element may not be able to detect a sufficient amount of light, so the exposure time is adjusted to be longer.

Then, as shown in FIG. 7, in step S21, Psz is defined as a plane having the same z coordinate as the bottom plane Psx of the transport platform 30, and z coordinate information is acquired while scanning the space formed by a plane including the plane Psx and a plane including the plane Psz, in the y axis direction from the edge Px (see FIGS. 8B and 8C).

Next, in step S22, it is determined whether or not the z axis information (height) is constant in the x axis direction or the y axis direction. Here, as shown in FIG. 8B, if it is determined that the z axis information (height) is constant, the processing proceeds to step S23, but as shown in FIG. 8C, if it is determined that the z axis information (height) is not constant, the processing proceeds to step S28.

Next, in step S23, since it was determined in step S22 that the z axis information (height) on the base Px is constant, it is tentatively assumed that the object P is not irregularly shaped and that there is a possibility that the object P is a transport platform 30 on which no load 31 has been placed.

Next, in step S24, depth information Ppx about the object P is defined from the plane Psx.

At this point, the exposure time may be adjusted, or the forklift 20 may be moved, so that the depth information Ppx (which refers to holes or recesses) can be easily obtained.

Next, in step S25, it is determined from the depth information Ppx whether or not there is depth within the plane Psx, that is, whether or not there are receiving portions such as the holes 30b within the plane Psx.

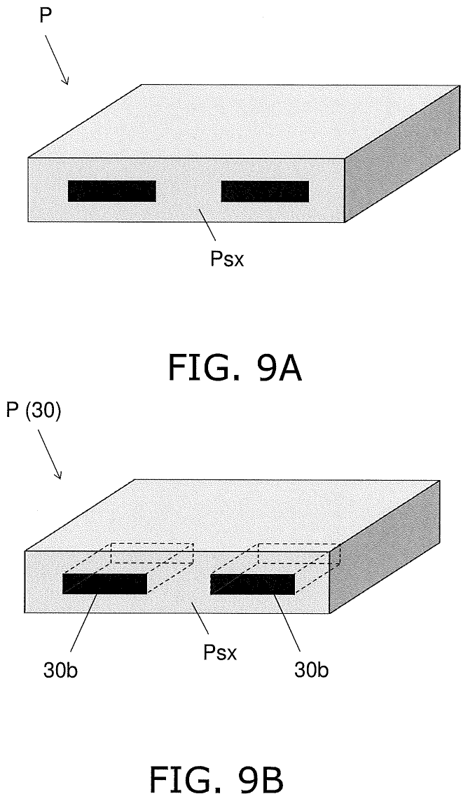

Here, with the transport possibility determination device 10 of this embodiment, as mentioned above, the TOF method is employed to measure (obtain) distance information corresponding to each pixel of the imaging element by the distance measurement unit 14. Accordingly, an object P having a black marking on its side surface as shown in FIG. 9A can be distinguished from an object P in which are formed holes 30b having depth information formed on its side surface as shown in FIG. 9B, on the basis of the obtained distance information.

Here, if it is determined that there is depth within the plane Psx, that is, if there are receiving portions such as the holes 30b (see FIG. 9B), the processing proceeds to step S26, and if it is determined that there is no depth (no receiving portions such as the holes 30b; see FIG. 9B), the processing proceeds to step S27.

Next, in step S26, since it was determined in step S25 that there is depth (the holes 30b) within the plane Psx, it is determined, on the basis of the depth information Ppx, that the object P is a transport platform 30 having receiving portions (holes 30b). Then, a transport platform table (see FIG. 5) is created in which is registered information such as the outer shape and size of the transport platform 30, the type of receiving portions (holes or recesses), etc.

Next, in step S27, since it was determined in step S25 that there is no depth (no holes 30b; the surface is substantially flat), it is determined that that object P does not have any receiving portions for inserting the arm portions 24 of the forklift 20, and is not a transport platform 30, and the processing is ended.

On the other hand, in step S28, since it was determined in step S22 that the z axis information (height) about the bottom edge Px is not constant in the x axis direction or the y axis direction, it is tentatively assumed that the object P is a transport platform 30 on which a load 31 is resting, or is an object with an irregular shape that is not a transport platform.

Next, in step S29, the object P tentatively identified in step S28 is matched with a transport platform 30 registered in the transport platform table by referring to the transport platform database 15a.

That is, in step S29, a part of the object P (especially the lower part) is matched according to whether it has the same outer shape, size, hole position, etc., as a transport platform 30 already registered in the transport platform table.

Next, in step S30, it is determined whether or not the object P includes a transport platform 30 according to whether or not part of the object P matches a registered transport platform 30 based on the result of matching in step S29.

Here, if it is determined there is a match with a registered transport platform 30, the processing proceeds to step S26, information about the transport platform 30 is registered in the transport platform table, and the processing is ended.

On the other hand, if it is determined that part of the object P does not match a registered transport platform 30, it is determined that the object P is not a transport platform 30, and the processing is ended.

Conveyance State Detection Method

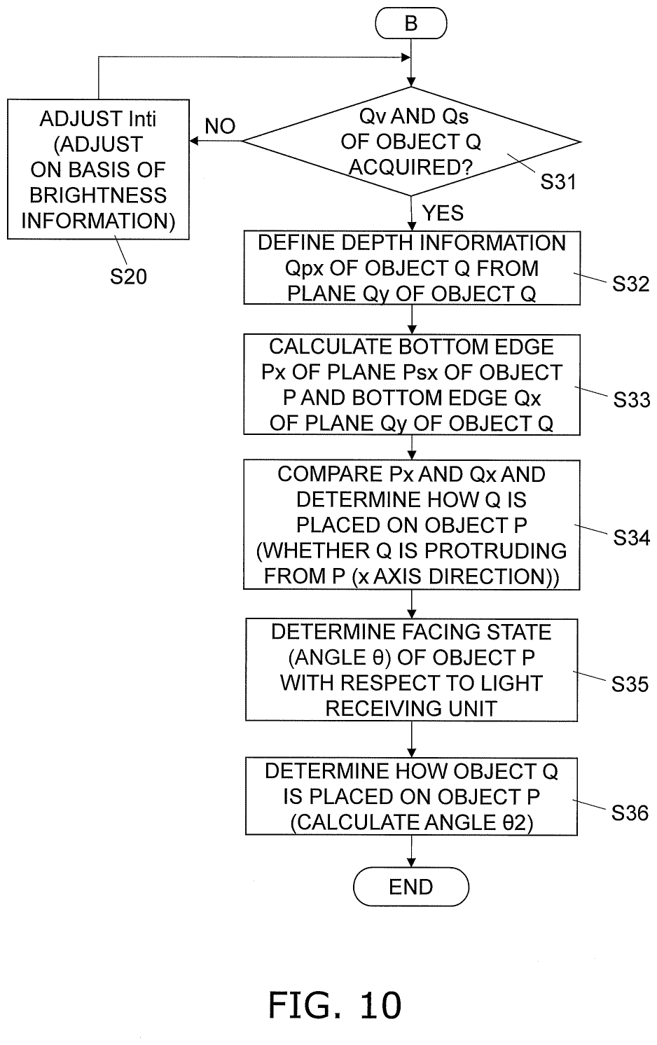

With the transport state detection method of this embodiment, it is determined whether the load 31 placed on the transport platform 30 detected by the transport platform detection processing discussed above is suitable, according to the flowchart shown in FIG. 10.

First, regarding an object P determined to be a transport platform 30 in step S30 and an object Q that has been placed on the upper surface thereof as a load 31, the front surface Py of the object P as seen from the light receiving unit 12 is defined from the outer shape Pvx and the plane Psx of the object P, and the length of the front surface Py in the x axis direction is termed Px. The plane of the object Q having the y coordinate closest to the front surface Py of the object P is defined as Qy, and the length of the plane Qy in the x axis direction is defined as Qx (see FIG. 8A).

First, in step S31, it is determined whether or not three-dimensional shape information (outer shape Qv and plane Qs) has been acquired for the object Q assumed to be a load 31 distinguished from the object P determined to be a transport platform 30.

Here, if the outer shape Qv and the plane Qs have been acquired, the processing proceeds to step S32, but if these have not been acquired, the exposure time Inti is adjusted for the lighting unit 11 (lighting device) and the light receiving unit 12 in step S20, and then the processing goes back to step S31 and the adjustment of the exposure time Inti is repeated until the outer shape Qv and the plane Qs are acquired.

Next, in step S32, depth information Qpx about the object Q is defined from the plane Qy of the object Q placed on the upper surface of the object P detected as a transport platform 30.

At this point, adjustment of the exposure time of the lighting unit 11 (lighting device) and the light receiving unit 12, movement of the forklift 20, or the like may be performed to make it easier to acquire depth information about the object Q.

Consequently, just as with the object P, depth information about the object Q can be obtained using distance information obtained by TOF method and obtained for each pixel of the image sensor.

Next, in step S33, in order to determine how the object Q is placed on the object P, the bottom edge Px of the plane Psx of the object P and the bottom edge Qx of the plane Qy of the object Q are calculated (see FIG. 8A).

Here, as discussed above, the bottom edge Px and the bottom edge Qx are calculated after using information about a transport platform 30 registered in the transport platform table to separate the object P determined to be a transport platform 30 from the object Q assumed to be a load 31 placed on the upper surface of the object P.

Then, the front surface Py of the object P is defined from the outer shape Pvx and the plane Psx of the object P, and the length of the bottom edge Px of the front surface Py in the x axis direction is calculated.

If we let Qy be the plane of the object Q having the y coordinate closest to the front surface Py of the object P, the length Qx of the plane Qy in the x axis direction is calculated.

The height Qz of the object Q is the maximum value for the size of the plane Qy in the z axis direction.

Then, in this step S33, the outer shape of the object Q is calculated from the length of the bottom edge Qx and the height Qz of the object Q. The outer shape is calculated, for example, as a contour line, as the surface area bounded by the contour line, or as the peripheral length of the contour line.

Next, in step S34, the bottom edge Px of the object P is compared with the bottom edge Qx of the object Q calculated in step S33, and it is determined how the object Q is positioned on the object P.

More specifically, whether or not the object Q protrudes from the upper surface of the object P, for example, is determined using the x axis information (Px) for the object P and the x axis information (Qx) for the object Q.

Next, in step S35, in order to determine the state of the load 31 placed on the upper surface of the transport platform 30, first, the positioning (angle θ1) of the object P detected as a transport platform 30 with respect to the light receiving unit 12 (imaging element) is checked.

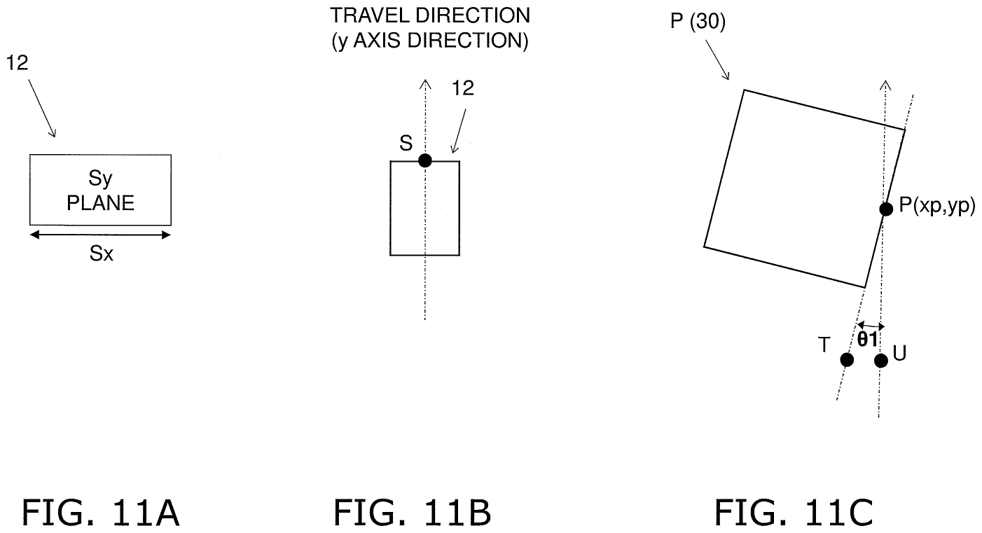

Here, if we let Sy be the plane of the light receiving unit 12 and let Sx be the length thereof in the x axis direction, as shown in FIGS. 11A to 11C, the angle θ1 is calculated as an angle indicating the position (orientation) of the front surface Py of the object P detected as a transport platform 30.

More specifically, the angle θ1 is calculated from the following relational formula (1) using the distance between the light receiving unit 12 and the object P (the distance in the y axis direction) and the facing relationship between the light receiving unit 12 and the object P, when a point U is placed on a line of y coordinate=yp that is parallel to points T and Sx on an extension of the bottom edge Px of the object P, as shown in FIG. 11C.

PT·PU=|PT∥PU|cos θ1 (1) (bold letters are vectors)

From this relational formula (1), the angle θ1 of the object P (transport platform 30) with respect to the light receiving unit 12 can be calculated.

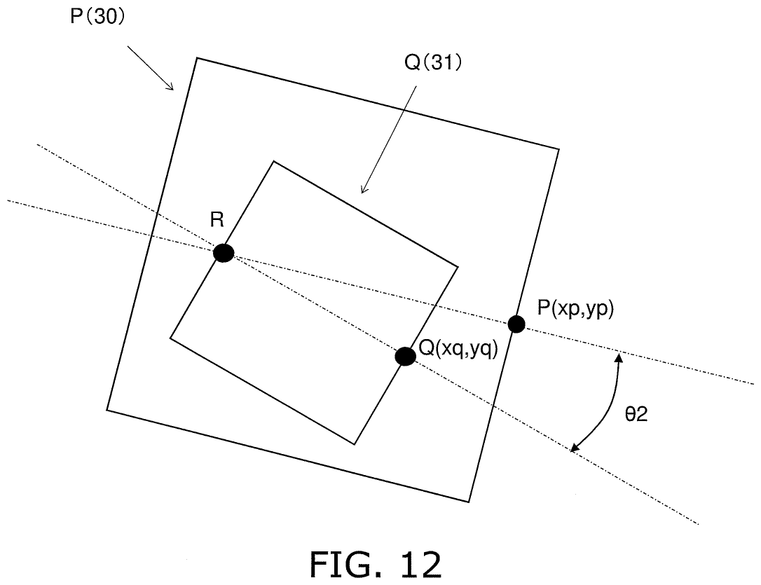

Next, in step S36, the angle θ2 shown in FIG. 12 is calculated in order to determine how the object Q (load 31) is placed on the upper surface of the object P (transport platform 30).

More specifically, the angle θ2, which indicates the placement state of the object Q on the object P, is calculated from the following relational formula (2), if we let Px/2 be the center point of the bottom edge Px of the front surface Py of the object P, let Qx/2 be the center point of the bottom edge Qx of the plane Qy of the object Q, and let point R be the intersection of the center line of the object P passing through the point P and the center line of the object Q passing through the point Q for the point P (x, y) and the point Q (x, y), respectively.

RP·RQ=|RP∥RQ|cos θ2 (2) (bold letters are vectors)

If the angle θ2 of the object Q (load 31) placed on the upper surface of the object P (transport platform 30) is calculated from this relational formula (2), it can be determined whether the load 31 is placed on the transport platform 30 within the proper range and in the proper orientation and position.

As a result, if it is determined that the state of the load 31 on the transport platform 30 is not suitable for transport, for example, the transport can be halted and the position of the load 31 can be corrected, for example.

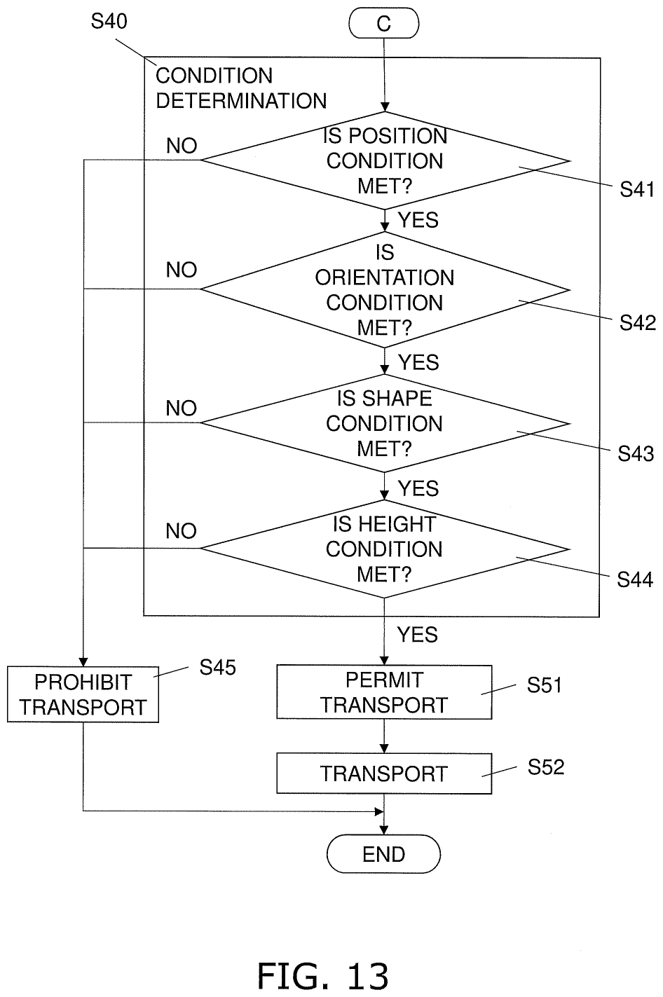

Transport Possibility Determination Method With the transport possibility determination method of this embodiment, it is determined whether transport is possible on the basis of state of the load 31 determined by the transport state detection processing discussed above, according to the flowchart shown in FIG. 13.

First, in step S40, it is determined whether or not the transportable condition is met, which is the condition for permitting the transport of the load 31 by the forklift 20, on the basis of the state of the load 31.

In this embodiment, the transportable condition is made up of the four conditions of a position condition, an orientation condition, a shape condition, and a height condition, for example. If all four of these conditions are met, the transportable condition is met. If at least one of the four conditions is not met, the transportable condition is not met.

Consequently, step S40 includes four types of determination processing: processing to determine whether the position condition is met (S41), processing to determine whether the orientation condition is met (S42), processing to determine whether the shape condition is met (S43), and processing to determine whether the height condition (S44) is met.

The position condition of step S41 is a condition that the relative position of the object Q (load 31) with respect to the object P (transport platform 30) calculated in step S34 be located within a predetermined reference area.

The reference area is set in the center part of the transport platform 30. The position condition is met when the object Q is within this reference area. If the object Q is outside the reference area, the position condition is not met, and so the transportable condition is not met.

The orientation condition of step S42 is a condition that the orientation of the object Q (load 31) with respect to the object P (transport platform 30) calculated in step S36 be within a predetermined reference range.

The reference range is a range in which θ2 is approximately 0° to ±20°, for example. The orientation condition is met when the orientation of the object Q is within this reference range. If the orientation is outside the reference range, the orientation condition is not met, and so the transportable condition is not met.

The shape condition of step S43 is a condition that the shape of the object Q (load 31) calculated in step S33 match a predetermined reference shape.

For example, the calculated shape is subjected to pattern matching with a predetermined reference shape. If the pattern matching determines that the calculated shape matches the reference shape, the shape condition is met. If it is determined that the calculated shape is different from the reference shape, the shape condition is not met and so the transportable condition is not met.

The height condition of step S44 is a condition that the height of the object Q (load 31) calculated in step S33 be equal to or less than a predetermined reference height.

If the height of the object Q is less than or equal to the reference height, the height condition is met. If the height of the object Q exceeds the reference height, the height condition is not met and so the transportable condition is not met.

Here, if the transportable condition is not met, the processing proceeds to step S45. If the transportable condition is met, the processing proceeds to step S51.

Next, in step S45, since one or more of the conditions in steps S41 to S44 was not met, the transport of the transport platform 30 and the load 31 to be measured is prohibited.

The transport control unit 25 receives a prohibition command from the transport possibility determination device 10 and suppresses operation involved in transport. Also, if the forklift 20 or the work site is provided with a device that displays or audibly outputs an alarm, an alarm may be generated to indicate that the load 31 is not in the proper state. This prompts the worker to put the load in its proper state.

On the other hand, in step S51, since all the conditions of steps S41 to S44 have been met, the transport of the transport platform 30 and the load 31 to be measured is allowed. The transport control unit 25 receives a permission command from the transport possibility determination device 10 and controls the operation involved in transport (S52).

For instance, the forklift 20 moves closer to the transport platform 30 so that the arm portions 24 are opposite the side of the transport platform 30 on which the holes 30b are formed. At this point, the spacing of the pair of arm portions 24 is adjusted, and the height of the pair of arm portions 24 is adjusted, on the basis of the shape of the holes 30b in the transport platform 30 registered in step S26.

Furthermore, the amount of extension of each of the arm portions 24 is adjusted on the basis of the position condition and orientation condition calculated in steps S34 and S35. The forklift 20 then travels toward the transport platform 30 so that the arm portions 24 are received in the holes 30b.

The arm portions 24 are raised while inserted in the holes 30b, and the transport platform 30 and the load 31 are supported and lifted by the arm portions 24. Moving the forklift 20 in this state allows the transport platform 30 and the load 31 to be moved to the desired location.

In the transport possibility determination method of this embodiment, transport by the forklift 20 is prohibited when it is determined that the position or orientation of the load 31 is biased with respect to the transport platform 30. Therefore, the forklift 20 can stably transport the load 31 without the worker having to monitor the orientation of the load 31.

The amount of extension and retraction of the arm portions is adjusted on the basis of the position and orientation of the load 31. Accordingly, even if the center of gravity of the transport platform 30 and the load 31 is offset from the center of the transport platform 30, the transport platform 30 and the load 31 can still be lifted stably.

Furthermore, in this method, transport is prohibited if the shape of the load 31 is outside the expected range or the height of the load 31 exceeds the reference height. Only a properly loaded load 31 will be transported, and the transport platform 30 and load 31 can be transported stably.

Main Feature 1

The transport possibility determination device 10 of this embodiment is a device for detecting a transport platform 30 to be transported by a forklift 20 with a load 31 placed thereon, and comprises the distance measurement unit 14 and the control unit 13. The distance measurement unit 14 measures the distance to an object according to the amount of reflection of the light emitted from the lighting unit 11 toward the object. The control unit 13 determines whether or not the object is a transport platform 30 on the basis of the distance to the object measured by the distance measurement unit 14.

Consequently, even if black markings or the like have been made on the side surface of an object placed on the floor surface FL, for example, whether these have the characteristics of a transport platform 30 to be transported by the forklift 20 (such as holes 30b or other such receiving portions into which the arm portions 24 of the forklift 20 are inserted) can be determined by using distance information.

As a result, it is possible to accurately determine whether or not a detected object is a transport platform 30.

Main Feature 2

The transport possibility determination device 10 of this embodiment is a device that determines the state of a load 31 on a transport platform 30 to be transported by the forklift 20 in a state in which the load 31 has been placed thereon, and comprises the distance measurement unit 14 and the control unit 13. The distance measurement unit 14 acquires information about the distance to the object according to the amount of reflection of the light emitted from the lighting unit 11 toward the object. The control unit 13 determines the state of the load 31 on the transport platform 30 on the basis of the information about the distance to the object acquired by the distance measurement unit 14.

Consequently, the state of the load 31 on the transport platform 30, such as the position, orientation, size, or offset of the load 31 (object Q) on the object P detected as a transport platform 30 can be easily determined by using distance information, for example.

As a result, it is possible to accurately determine whether or not the determined state of the load 31 on the transport platform 30 is suitable for transport.

Main Feature 3

In the transport possibility determination device 10 of this embodiment, the control unit 13 determines whether or not the transportable condition, which is a condition for permitting the transport of the load by the forklift 20, is met on the basis of the determination result for the load state.

Consequently, the state of the load 31 on the transport platform 30 can be determined very accurately before transport is started, so if it transport is determined to be possible on the basis of this determination result, transport by the forklift 20 is permitted, which makes it less likely that problems such as collapse of load during transport will occur.

### OTHER EMBODIMENTS

An embodiment of the present invention was described above, but the present invention is not limited to or by the above embodiment, and various modifications are possible without departing from the gist of the invention.

(A)

In the above embodiment, an example was given in which the present invention was realized as a transport possibility determination device and a transport possibility determination method. However, the present invention is not limited to this.

For example, the present invention may be realized as a program that causes a computer to execute the transport possibility determination method described above.

This program is stored in the memory (storage unit) installed in the transport possibility determination device, and the CPU reads the transport possibility determination program stored in the memory and causes the hardware to execute the steps. More specifically, the CPU reads the transport possibility determination program and executes a distance information acquisition step, a determination step, and a condition determination step, thereby obtaining the same effect as above.

Also, the present invention may be realized as a recording medium on which is stored a transport possibility determination program.

(B)

In the above embodiment, an example was given in which, in determining whether or not transport is possible, the determination was made according to whether or not the four conditions, namely, position, orientation, shape, and height, of the load 31 on the transport platform 30 were met, but the present invention is not limited to this.

For example, one or more of the above four conditions may be set as a condition for whether or not transport is possible, according to the type and size of the load to be transported, the form and capacity of the transport device, and so forth, or the possibility of transport may be determined according to some other condition besides the above four conditions, or some other condition that is set in addition to the above four conditions.

(C)

In the above embodiment, an example was given in which light in a broad sense was used as the electromagnetic waves with which the object is irradiated from the lighting unit 11. However, the present invention is not limited to this.

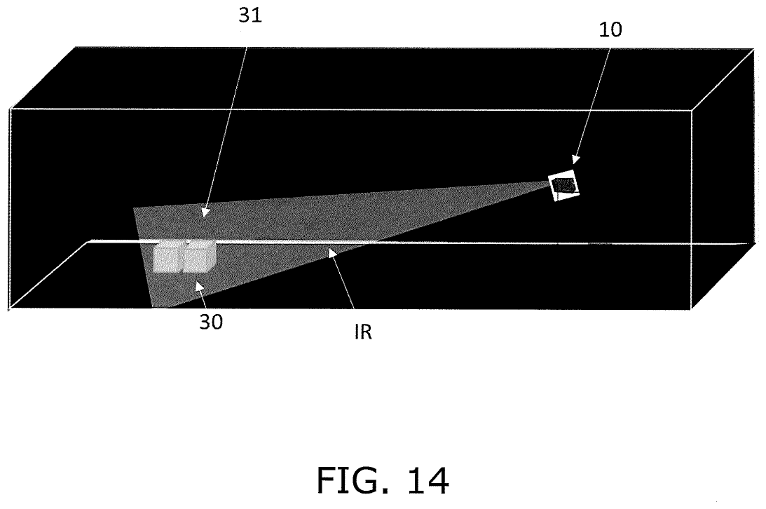

For example, when infrared light IR is used as the light emitted from the lighting device at the object, as shown in FIG. 14, even when the transport work is carried out in a dark room, if the reflection of the infrared light IR is sensed and information about the distance to the object is obtained, it will still be possible to detect the transport platform 30 and determine the state of the load 31 on the transport platform 30, which is the same effect as described above.

(D)

In the above embodiment, an example was given in which the transport possibility determination device 10 was built into a distance measurement device mounted on the forklift (transport device) 20. However, the present invention is not limited to this.

For example, a transport possibility determination device may be used as a device installed separately from the transport device. Alternatively, the configuration may be such that the transport possibility determination device of the present invention is installed in a controller of a transport device such as a forklift.

(E)

In the above embodiment, an example was given in which the determination of whether or not the detected object P was a transport platform 30 was made on the basis of whether there were any receiving portions (holes 30b). However, the present invention is not limited to this.

For example, in addition to the presence or absence of receiving portions, other factors such as the size and position of the receiving portions may be added to determine whether or not the object is a transport platform.

(F)

In the above embodiment, an example was given in which distance information was calculated by sensing the amount of reflection of the light L1 with which the object is irradiated. However, the present invention is not limited to this.

For example, information about the distance to the object calculated by a TOF sensor provided outside the device may be acquired to detect the transport platform and determine the transport state.

(G)

In the above embodiment, an example was given in which light in a broad sense was used as the electromagnetic waves with which the object was irradiated from the lighting unit 11. However, the present invention is not limited to this.

For example, the electromagnetic waves emitted from the irradiation device toward the target object include, in addition to light in a broad sense (ultraviolet light and visible light), X-rays and gamma rays with shorter wavelengths than light, microwaves with longer wavelengths than light, and broadcasting radio waves (short wave, medium wave, long wave), ultrasonic waves, elastic waves, quantum waves, and other such electromagnetic waves.

(H)

In the above embodiment, an example was given in which the forklift 20 was used as the transport device on which the transport possibility determination device 10 was mounted has been described. However, the present invention is not limited to this.

For example, the transport possibility determination device of the present invention may be installed in another transport device, such as an AGV (Automatic Guided Vehicle), an AMR (Autonomous Mobile Robot), or another such transport robot or the like.

Also, the transport possibility determination device of the present invention may be installed in a non-traveling transport device in addition to being installed in a self-propelled transport device.

(I)

In the above embodiment, as shown in FIG. 3, an example was given in which a storage unit 15 for storing a transport platform database 15a including a transport platform table (see FIG. 5) in which is registered information about the characteristics (size, shape, etc.) of transport platforms 30, was provided in the transport possibility determination device 10. However, the present invention is not limited to this.

For example, some other storage means, such as an external server, may be used as the storage unit for storing the transport platform database.

(J)

In the above embodiment, an example was given in which a transport platform 30 made of resin was detected by the transport possibility determination device 10 of the present invention. However, the present invention is not limited to this.

For example, the material of the transport platform is not limited to resin, and may instead be wood, metal, rubber, or some other material besides resin.

(K)

In the above embodiment, an example was given in which the reflection of light emitted toward the front of a transport device such as the forklift 20 was detected to detect a transport platform 30 or the like in front of the transport device. However, the present invention is not limited to this.

For example, the configuration may be such that the reflection of light emitted toward the rear or the side of the transport device is detected to detect a transport platform or the like behind or to the side of the transport device.

### REFERENCE SIGNS LIST

1 distance measurement device
10 transport possibility determination device
11 lighting unit (lighting device)
12 light receiving unit
13 control unit (determination unit, condition determination unit)
14 distance measurement unit (distance information acquisition unit)
15 storage unit
15a transport platform database
16 transport platform information acquisition unit
17 load state acquisition unit
17a position information acquisition unit
17b orientation information acquisition unit
17c shape information acquisition unit
17d height information acquisition unit
20 forklift (transport device)
21 vehicle body portion
22a, 22b wheels
23 drive unit
24 arm portion
25 transport control unit
25a travel control unit
25b arm control unit
26 travel actuator
27 braking device
28 lift actuator
30 transport platform
30a main body portion
30b hole (receiving portion)
31 load
100 transport unit
130 transport platform
130a main body portion
130b recess (receiving portion)
FL floor surface
IR infrared rays (electromagnetic waves)
L1 light (electromagnetic waves)
P object
Q object

1. A transport possibility determination device, comprising:
a distance information acquisition unit configured to acquire information about a distance to an object according to an amount of reflection of electromagnetic waves emitted from a lighting device at the object;
a determination unit configured to determine a state of a load when the object is a transport platform on which the load has been placed, on the basis of the information about the distance to the object acquired by the distance information acquisition unit; and
a condition determination unit configured to determine whether or not a transportable condition, which is a condition for permitting a transport device to transport the load, is met on the basis of the state of the load determined by the determination unit.

2. The transport possibility determination device according to claim 1,
wherein the determination unit determines a relative position of the load with respect to the transport platform as the state of the load, and
the transportable condition includes a position condition that a relative position be located within a specific reference area.

3. The transport possibility determination device according to claim 1,
wherein the determination unit determines an orientation of the load with respect to the transport platform as the state of the load, and
the transportable condition includes an orientation condition that the orientation of the load with respect to the transport platform be within a specific reference range.

4. The transport possibility determination device according to claim 1,
wherein the determination unit determines a shape of the load as the state of the load, and
the transportable condition includes a shape condition that the shape of the load be within a specific reference range.

5. The transport possibility determination device according to claim 1,
wherein the determination unit determines a height of the load as the state of the load, and
the transportable condition includes a height condition that the height be within a specific reference height.

6. The transport possibility determination device according to claim 1,
wherein the determination unit determines whether the object is the transport platform on the basis of the distance information.

7. The transport possibility determination device according to claim 6,
wherein the transport platform has a receiving portion into which an arm member of the transport device is inserted, and
the determination unit uses the distance information to determine whether or not the object is the transport platform according to at least one of the following: a presence or absence, size, and position of the receiving portion.

8. The transport possibility determination device according to claim 6,
wherein the transport platform has a receiving portion into which an arm member of the transport device is inserted, and
the determination unit uses the distance information to determine whether the object is an empty transport platform, or the transport platform on which the load has been placed, or an object other than the transport platform according to at least one of the following: a presence or absence, size, and position of the receiving portion.

9. The transport possibility determination device according to claim 6,
wherein the determination unit uses the distance information to detect a floor surface on which the object has been placed, and detects an object having a height from the floor surface as a candidate for the transport platform.

10. The transport possibility determination device according to claim 9,
wherein the determination unit sets an outer shape of the object detected as a candidate for the transport platform on the basis of the distance information.

11. The transport possibility determination device according to claim 10,
wherein the determination unit sets the outer shape using binarized data obtained on the basis of the distance information or information about a brightness of a captured image of the object.

12. The transport possibility determination device according to claim 10,
wherein when the binarized data is not obtained by the determination unit, an exposure time for emitting and receiving the electromagnetic waves emitted from the lighting device is adjusted.

13. The transport possibility determination device according to claim 10,
wherein the determination unit sets a detection surface on which a receiving portion of the transport platform is assumed to be formed, on the basis of the outer shape that has been set.

14. The transport possibility determination device according to claim 13,
wherein the determination unit determines whether or not an object is the transport platform according to information about a depth of the receiving portion on the detection surface.

15. The transport possibility determination device according to claim 13,
wherein the determination unit detects a position in a substantially horizontal direction of the load existing at the same axial coordinates as the detection surface of the object assumed to be the transport platform, and determines the state of the load.

16. The transport possibility determination device according to claim 13,
wherein the determination unit senses an orientation of the load with respect to the detection surface of the object assumed to be the transport platform, and
determines a state of the load.

17. The transport possibility determination device according to claim 6,
further comprising a storage unit configured to store detection data about the transport platform determined by the determination unit to be the transport platform.

18. The transport possibility determination device according to claim 1,
wherein the electromagnetic waves are infrared rays.

19. A distance measurement device, comprising:
the transport possibility determination device according to claim 1;
a lighting device configured to irradiate the object with electromagnetic waves; and
a light receiving unit configured to sense the amount of reflection of the electromagnetic waves emitted from the lighting device.

20. The distance measurement device according to claim 19,
further comprising a control unit configured to adjust an amount of electromagnetic waves emitted from the lighting device, and an exposure time for the light receiving unit to sense the amount of reflection of the electromagnetic waves.

21. The distance measurement device according to claim 20,
wherein the control unit adjusts the exposure time according to the distance to the object.

22. A transport unit, comprising:
the distance measurement device according to claim 21; and
a transport device configured to transport the load placed on the transport platform.

23. The transport unit according to claim 22,
wherein the transport device comprises:
an arm member that is inserted into a receiving portion of the transport platform; and
a transport control unit configured to control an operation of the arm member,
and when the condition determination unit determines that the transportable condition has been met, the transport control unit controls the operation of the arm member on the basis of the state of the load determined by the determination unit.

24. A transport possibility determination method, comprising:
a distance information acquisition step of acquiring information about a distance to an object according to an amount of reflection of electromagnetic waves emitted from a lighting device at the object;
a determination step of determining a state of a load when the object is a transport platform on which the load has been placed, on the basis of the information about the distance to the object acquired in the distance information acquisition step; and
a transport possibility determination step of determining whether or not a transportable condition, which is a condition for permitting a transport device to transport the load, is met on the basis of the state of the load determined in the determination step.

25. A transport possibility determination program,
which causes a computer to execute the transport possibility determination method according to claim 24.
